(19) United States
(12) Patent Application Publication
(10) Pub. No.: US 2021/0206668 A1
(43) Pub. Date: Jul. 8, 2021

(54) ELECTROCHEMICAL CELL ARRANGEMENT AND METHOD FOR SEPARATING IMPURITIES

(71) Applicant: Lithtech Industries Pty Ltd, Queens Park (AU)

(72) Inventors: Adam Blunn, Goonellabah (AU); Scott Eastwood, Swan Bay (AU)

(21) Appl. No.: 17/249,033

(22) Filed: Feb. 17, 2021

Related U.S. Application Data
(63) Continuation of application No. PCT/AU2019/000099, filed on Aug. 17, 2019.

(30) Foreign Application Priority Data
Aug. 17, 2018 (AU) 2018903033

(51) Int. Cl. C02F 1/467; C02F 1/58

(52) U.S. Cl. CPC C02F 1/4678; C02F 2101/10; C02F 1/58

(57) ABSTRACT

An electrochemical method for separating impurities from aqueous solutions, comprises the steps of:
Circulating an aqueous feed solution containing an impurity ion to a cathode chamber of an electrochemical cell containing a cathode;
Circulating an acidic electrolyte solution to an anode chamber containing an anode;
Separating the anode chamber from the cathode chamber with a central chamber, to form a 3-chamber cell, having an anion exchange membrane forming a boundary between the cathode chamber and the central chamber, and a cation exchange membrane forming a boundary between the anode chamber and the central chamber;
Circulating or adding a chloride solution within or to the central chamber;
Applying a current across the anode and cathode to facilitate hydrogen ions generated at the anode to migrate through the cation exchange membrane into the central chamber, and chloride ions generated in the cathode chamber to migrate across the anion exchange membrane to the central chamber to form hydrochloric acid;
Wherein the impurity ions are precipitated as hydroxide compounds in the cathode chamber to produce an impurity depleted solution.

### TECHNICAL FIELD

The present invention relates to the removal of magnesium from aqueous solutions. More particularly, the present invention relates to the removal of magnesium from brine, saline, seawater and metallurgical solutions.

### BACKGROUND ART

The following discussion of the background art is intended to facilitate an understanding of the present invention only. The discussion is not an acknowledgment or admission that any of the material referred to is or was part of the common general knowledge as at the priority date of the application.

Impurities (for example magnesium or aluminium) present in aqueous solutions, particularly saline, brine or seawater solutions can inhibit separation and recovery of valuable salts, metals or other compounds from solution.

Current processes that recover magnesium from brines or seawater use variations on soda ash or caustic precipitation. For example, Korean patent KR101663515 (B1) discloses a method for the precipitation of Mg(OH)₂ or MgCO₃ through pH control.

The use of membranes for magnesium removal is limited because of the issue of membrane fouling once Mg is precipitated. PCT/NO99/00343 discloses a method of precipitating magnesium hydroxide from seawater which uses Electrodialysis and Electro-Electrodialysis (forms of ionic exchange (IX) membranes). However, as with many other literature sources, the Mg (and Ca) precipitation from the brine must be conducted in a separate step prior to IX membrane processing.

Further, these processes require the addition and/or regeneration of caustic preparations to facilitate Mg precipitation. Mixing caustic preparations with seawater is disadvantageous because it results in loss of the fine control over precipitation that can otherwise be achieved with incremental adjustments. This, in turn, leads to localised and uncontrolled precipitation (i.e. complete, non-selective precipitation of all salts, metals or other compounds from solution).

There is currently no satisfactory process which enables separation and direct precipitation of magnesium as a hydroxide with sufficient purity to be economical.

The present invention seeks to overcome, or at least ameliorate, one or more of the deficiencies of the prior art mentioned above, or to provide the consumer with a useful or commercial choice.

Each document, reference, patent application or patent cited in this text is expressly incorporated herein in their entirety by reference, which means that it should be read and considered by the reader as part of this text. That the document, reference, patent application or patent cited in this text is not repeated in this text is merely for reasons of conciseness.

Throughout this specification, unless the context requires otherwise, the term “brine solution”, will be understood to include salt, seawater, and metallurgical solutions containing same.

Reference to metallurgical solutions throughout this specification will be deemed to apply to any metal sought to be recovered from a metal source material, including but not limited to an ore, hard rock, or slurry.

Reference to “leach solutions” throughout this specification includes but is not limited to, any metal containing solution, metallurgical solution, salar brine, or brine concentrate.

Reference to metals will be deemed to include any metal, including but not limited to, lithium.

Throughout this specification, unless the context requires otherwise, the word “comprise” or variations such as “comprises” or “comprising”, will be understood to imply the inclusion of a stated integer or group of integers but not the exclusion of any other integer or group of integers.

### SUMMARY OF INVENTION

In accordance with the present invention there is provided an electrochemical method for separating impurities from aqueous solutions, comprising the steps of:
Circulating an aqueous feed solution containing an impurity ion to a cathode chamber of an electrochemical cell containing a cathode;
Circulating an acidic electrolyte solution to an anode chamber containing an anode;
Separating the anode chamber from the cathode chamber with a central chamber, to form a 3-chamber cell, having an anion exchange membrane forming a boundary between the cathode chamber and the central chamber, and a cation exchange membrane forming a boundary between the anode chamber and the central chamber;
Circulating or adding a chloride solution within or to the central chamber;
Applying a current across the anode and cathode to facilitate hydrogen ions generated at the anode to migrate through the cation exchange membrane into the central chamber, and chloride ions generated in the cathode chamber to migrate across the anion exchange membrane to the central chamber to form hydrochloric acid;
Wherein the impurity ions are precipitated as hydroxide compounds in the cathode chamber to produce an impurity depleted solution.

Preferably, the aqueous feed solution comprises any one of brine, salt or seawater.

Preferably the impurity ions comprise any one or more of magnesium or aluminium.

Preferably the acidic electrolyte solution in the anode chamber is any one of sulfuric, hydrochloric or phosphoric acid.

Preferably, the chloride solution in the central chamber is an acidic chloride solution.

In accordance with the present invention there is provided an electrochemical method for separating magnesium and/or aluminium from aqueous solutions, comprising the steps of:
Circulating an aqueous feed solution containing magnesium and/or aluminium ions to a cathode chamber of an electrochemical cell containing a cathode
Circulating an acidic electrolyte solution to an anode chamber containing an anode;
Separating the anode chamber from the cathode chamber with a central chamber, to form a 3-chamber cell, having an anion exchange membrane forming a boundary between the cathode chamber and the central chamber, and a cation exchange membrane forming a boundary between the anode chamber and the central chamber;
Circulating a chloride solution to the central chamber;
Applying a current across the anode and cathode to facilitate hydrogen ions generated at the anode to migrate through the cation exchange membrane into the central chamber, and chloride ions generated in the cathode chamber to migrate across the anion exchange membrane to the central chamber to form hydrochloric acid in the central chamber;
Wherein magnesium and/or aluminium ions are precipitated as hydroxide compounds in the cathode chamber to produce a magnesium and/or aluminium depleted solution.

Preferably, the aqueous feed solution comprises any one of brine, salt or seawater.

Preferably the acidic electrolyte solution in the anode chamber is any one of sulfuric, hydrochloric or phosphoric acid.

Preferably, the chloride solution in the central chamber is an acidic chloride solution.

In accordance with the present invention there is provided an electrochemical method for separating magnesium and/or aluminium from a metallurgical solution, comprising the steps of:
Circulating a metallurgical feed solution containing magnesium and/or aluminium ions to a cathode chamber of an electrochemical cell containing a cathode;
Circulating an acidic electrolyte solution to an anode chamber containing an anode;
Separating the anode chamber from the cathode chamber with a central chamber, to form a 3-chamber cell, having an anion exchange membrane forming a boundary to the cathode chamber, and a cation exchange membrane forming a boundary to the anode chamber;
Circulating a chloride solution to the central chamber;
Applying a current across the anode and cathode to facilitate hydrogen ions generated at the anode to migrate through the cation exchange membrane into the central chamber, and chloride ions generated in the cathode chamber to migrate across the anion exchange membrane to the central chamber to form hydrochloric acid in the central chamber;
Wherein magnesium and/or aluminium ions are precipitated as hydroxide compounds in the cathode chamber to produce a magnesium and/or aluminium depleted metallurgical solution.

Preferably, the metallurgical solution contains lithium.

Preferably the acidic electrolyte solution in the anode chamber is any one of sulfuric, hydrochloric or phosphoric acid.

Preferably, the chloride solution in the central chamber is an acidic chloride solution.

In accordance with the present invention there is provided a 3-chamber electrochemical cell for separating impurity ions from an aqueous solution, comprising:
A cathode chamber containing a cathode and at least one boundary of the cathode chamber being formed by an anion exchange membrane;
An anode chamber containing an anode and at least one boundary of the anode chamber being formed from a cation exchange membrane;
A central chamber formed between said anion and cation exchange membranes;
A power source connected to the anode and the cathode to facilitate applying a current therebetween;
Wherein an aqueous feed solution containing impurity ions is fed to the cathode chamber where impurity ions are precipitated as hydroxides and chloride ions migrate through the anion exchange membrane to the central chamber, and an acidic electrolyte solution is fed to the anode chamber where hydroxide ions are generated and migrate through the cation exchange membrane to the central chamber to form hydrochloric acid in the central chamber and an impurity depleted aqueous solution in the cathode chamber.

In accordance with the present invention there is provided a 3-chamber electrochemical cell for separating magnesium and/or aluminium ions from an aqueous solution, comprising:
A cathode chamber containing a cathode and at least one boundary of the cathode chamber being formed by an anion exchange membrane;
An anode chamber containing an anode and at least one boundary of the anode chamber being formed from a cation exchange membrane;
A central chamber formed between said anion and cation exchange membranes;
A power source connected to the anode and the cathode to facilitate applying a current therebetween;
Wherein an aqueous feed solution containing magnesium and/or aluminium ions is fed to the cathode chamber where they are precipitated as hydroxides and chloride ions migrate through the anion exchange membrane to the central chamber, and an acidic electrolyte solution is fed to the anode chamber where hydroxide ions are generated and migrate through the cation exchange membrane to the central chamber to form hydrochloric acid in the central chamber, and a magnesium and/or aluminium depleted aqueous solution is formed in the cathode chamber.

In accordance with the present invention there is provided a 3-chamber electrochemical cell for separating magnesium and/or aluminium ions from a metallurgical solution, comprising:
A cathode chamber containing a cathode and at least one boundary of the cathode chamber being formed by an anion exchange membrane;
An anode chamber containing an anode and at least one boundary of the anode chamber being formed from a cation exchange membrane;
A central chamber formed between said anion and cation exchange membranes;
A power source connected to the anode and the cathode to facilitate applying a current therebetween;
Wherein a metallurgical feed solution containing magnesium and/or aluminium ions is fed to the cathode chamber where they are precipitated as hydroxides and chloride ions migrate through the anion exchange membrane to the central chamber, and an acidic electrolyte solution is fed to the anode chamber where hydroxide ions are generated and migrate through the cation exchange membrane to the central chamber to form hydrochloric acid in the central chamber, and a magnesium and/or aluminium depleted metallurgical solution is formed in the cathode chamber.

In preferred embodiments of the present invention, the electrochemical cell arrangement and method of removing impurities of the present invention are configured for use as a stand-alone cell.

In other preferred embodiments of the present invention, the electrochemical cell arrangement and method of removing impurities are configured for use or incorporated as part of an inline continuous flow operation.

### BRIEF DESCRIPTION OF THE DRAWINGS

Further features of the present invention are more fully described in the following description of several non-limiting embodiments thereof. This description is included solely for the purposes of exemplifying the present invention. It should not be understood as a restriction on the broad summary, disclosure or description of the invention as set out above. The description will be made with reference to the accompanying drawings in which:

FIG. 1 is a depiction of an embodiment of the electrochemical cell arrangement of the present invention.

FIG. 2 shows experimental results from applying the electrochemical cell arrangement and method of the present invention to a synthetic lithium leach solution.

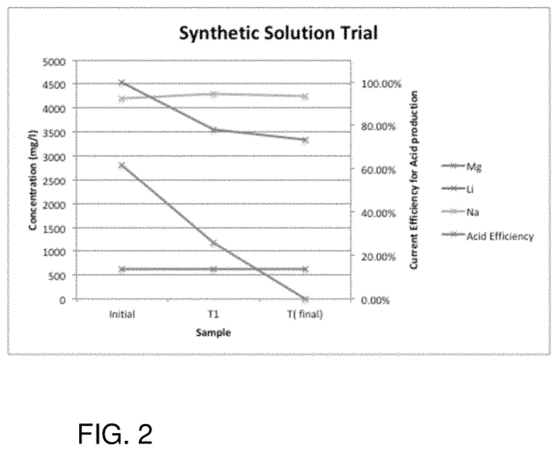

FIG. 3 shows experimental results from applying the electrochemical cell arrangement and method of the present invention to a test lithium solution made up with seawater.

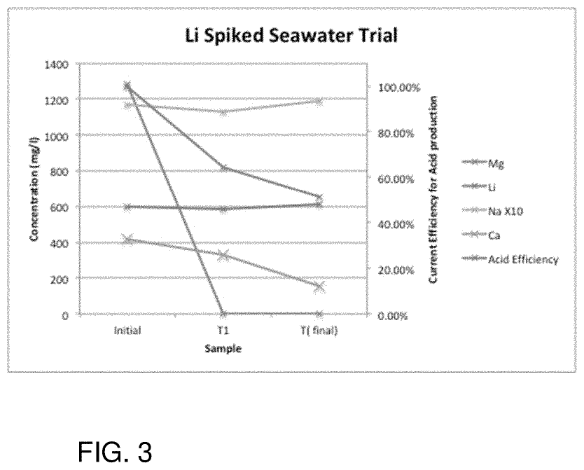

### DESCRIPTION OF EMBODIMENTS

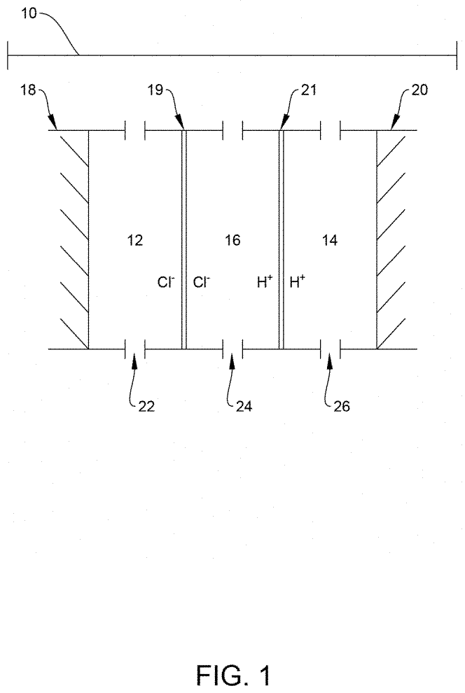

A description of the method of the present invention is described with reference to FIG. 1.

An electrochemical cell arrangement 10 in the form of an electro/electrodialysis cell comprises a cathode chamber 12, an anode chamber 14 and a central chamber 16. A cathode 18 is located in or forms a boundary to the cathode chamber 12 and an anion exchange membrane 19 forms an adjoining boundary between the cathode chamber 12 and the central chamber 16. An anode 20 is located in or forms a boundary to the anode chamber 14 and a cation exchange membrane 21 forms an adjoining boundary between the anode chamber 14 and the central chamber 16.

An aqueous feed solution 22, for example a brine, salt, seawater or metallurgical solution, is fed to the cathode chamber 12. Hydroxide ions are produced at the cathode 18 and react with impurities, for example magnesium and/or aluminium, in the aqueous feed solution 22 to form hydroxide precipitate/s that settle out of solution. Hydrogen gas produced at the cathode 18 prevents the hydroxide precipitate from fouling the cathode.

A chloride solution 24, for example hydrochloric acid, but preferably phosphoric acid, is fed to the central chamber 16. Phosphoric acid and other non-oxidisable and non-oxidising strongly dissociated acids are preferred to hydrochloric acid as hydrochloric acid forms gaseous chlorine at the anode. Chloride ions present in the aqueous feed solution 22 proceed to migrate across the anion exchange membrane 19 into the central chamber 16. An acidic electrolyte solution 26 is fed to the anode chamber 14, where hydrogen ions are formed and proceed to migrate across the cation exchange membrane 21 into the central chamber 16. These hydrogen ions form hydrochloric acid with the chloride ions that have migrated into the central chamber 16 across the anion exchange membrane 19.

With the impurities having precipitated as hydroxides in the cathode chamber, an impurity depleted solution is formed and can be separated from the precipitated impurities for further processing.

This method has several advantages over traditional methods for removal of impurities, for example, such as magnesium or aluminium from solutions. Those skilled in the art will recognize that other impurities may be removed without departing from the scope of the present invention. The 3-chamber configuration enables chloride to be removed from the feed solution to produce hydrochloric acid and magnesium to be precipitated as magnesium hydroxide, which are both potentially revenue generating streams not available to traditional treatment processes. Further, where the feed stream is a metallurgical stream, the impurities are removed enabling better metal recoveries.

The 3-chamber configuration prevents the formation of chlorine, which is a further advantage over the electrochemical methods of the prior art which use a single membrane configuration. This has significant safety and environmental implications for commercial application.

### EXAMPLES

### Example 1

6 litres of solution with 1300 mg/l Magnesium; 10800 mg/l Na; and balance as Chloride was electrolysed for 4 hours with 3.0 amps.

The cell was as described in the present invention, with two membranes, acid was recovered in the middle chamber by receiving chloride from the cathode chamber via the anion exchange membrane and hydrogen ions from the anode chamber via the cation exchange membrane, magnesium was precipitated in the cathode chamber—passed out of the cell and settled in the batch recycle container; sulphuric acid was used as supporting anolyte—water was electrolysed producing oxygen and hydrogen ions at the anode, and hydrogen and hydroxide ions at the cathode.

The results from this test are that after 4 hours passing 3.0 amperes, magnesium was reduced to 850 mg/l; sodium was unchanged, and 5.66 grams of HCl was generated (36% current efficiency).

### Example 2

This experiment was performed similarly to Example 1, but this time using a different IX membrane supplier and only 3 litres as a feed solution. The solution was electrolyzed for 2 hours at 3.0 amperes. The results are depicted below.

Initial Solution: Mg—1280 mg/l; Ca—420 mg/l; Na 10800 mg/l
Final Solution: Mg—690 mg/l; Ca—420 mg/l; Na 10800 mg/l
5.43 g of HCl was generated (72.7% current efficiency).

Any number of IX membranes are suitable for use with the present invention and there is no preference according to membrane manufacturer.

The electrochemical cell arrangement and method of removing impurities of the present invention can be used as a stand-alone cell or may be incorporated as part of an inline continuous flow operation according to the requirements of the user.

Modifications and variations such as would be apparent to the skilled addressee are considered to fall within the scope of the present invention.

1. An electrochemical method for separating impurities including alkaline earth metals and aluminium from aqueous solutions, comprising the steps of:
Circulating an aqueous feed solution containing an impurity ion to a cathode chamber of an electrochemical cell containing a cathode;
Circulating an acidic electrolyte solution to an anode chamber containing an anode;
Separating the anode chamber from the cathode chamber with a central chamber, to form a 3-chamber cell, having an anion exchange membrane forming a boundary between the cathode chamber and the central chamber, and a cation exchange membrane forming a boundary between the anode chamber and the central chamber;
Circulating or adding a chloride solution within or to the central chamber;
Applying a current across the anode and cathode to facilitate hydrogen ions generated at the anode to migrate through the cation exchange membrane into the central chamber, and chloride ions generated in the cathode chamber to migrate across the anion exchange membrane to the central chamber to form hydrochloric acid; and
Wherein the impurity ions are precipitated as hydroxide compounds in the cathode chamber to produce an impurity depleted solution.

2. The method of claim 1, wherein the aqueous feed solution comprises any one of brine, salt or seawater.

3. The method of claim 1, wherein the impurity ions comprise any one or more of magnesium or aluminium.

4. The method of claim 1, wherein the acidic electrolyte solution in the anode chamber is any one of sulfuric, hydrochloric or phosphoric acid.

5. The method of claim 1, wherein, the chloride solution in the central chamber is an acidic chloride solution.

6. An electrochemical method for separating magnesium and/or aluminium from aqueous solutions, comprising the steps of:
Circulating an aqueous feed solution containing magnesium and/or aluminium ions to a cathode chamber of an electrochemical cell containing a cathode
Circulating an acidic electrolyte solution to an anode chamber containing an anode;
Separating the anode chamber from the cathode chamber with a central chamber, to form a 3-chamber cell, having an anion exchange membrane forming a boundary between the cathode chamber and the central chamber, and a cation exchange membrane forming a boundary between the anode chamber and the central chamber;
Circulating a chloride solution to the central chamber;
Applying a current across the anode and cathode to facilitate hydrogen ions generated at the anode to migrate through the cation exchange membrane into the central chamber, and chloride ions generated in the cathode chamber to migrate across the anion exchange membrane to the central chamber to form hydrochloric acid in the central chamber; and
Wherein magnesium and/or aluminium ions are precipitated as hydroxide compounds in the cathode chamber to produce a magnesium and/or aluminium depleted solution.

7. The method of claim 6, wherein the aqueous feed solution comprises any one of brine, salt or seawater.

8. The method of claim 6, wherein the acidic electrolyte solution in the anode chamber is any one of sulfuric, hydrochloric or phosphoric acid.

9. The method of claim 6 wherein, the chloride solution in the central chamber is an acidic chloride solution.

10. An electrochemical method for separating magnesium and/or aluminium from a metallurgical solution, comprising the steps of:
Circulating a metallurgical feed solution containing magnesium and/or aluminium ions to a cathode chamber of an electrochemical cell containing a cathode;
Circulating an acidic electrolyte solution to an anode chamber containing an anode;
Separating the anode chamber from the cathode chamber with a central chamber, to form a 3-chamber cell, having an anion exchange membrane forming a boundary to the cathode chamber, and a cation exchange membrane forming a boundary to the anode chamber;
Circulating a chloride solution to the central chamber;
Applying a current across the anode and cathode to facilitate hydrogen ions generated at the anode to migrate through the cation exchange membrane into the central chamber, and chloride ions generated in the cathode chamber to migrate across the anion exchange membrane to the central chamber to form hydrochloric acid in the central chamber; and
Wherein magnesium and/or aluminium ions are precipitated as hydroxide compounds in the cathode chamber to produce a magnesium and/or aluminium depleted metallurgical solution.

11. The method of claim 10 wherein the metallurgical solution contains lithium.

12. The method of claim 10 wherein the acidic electrolyte solution in the anode chamber is any one of sulfuric, hydrochloric or phosphoric acid.

13. The method of any of claim 10 wherein the chloride solution in the central chamber is an acidic chloride solution.

14. A three chamber electrochemical cell for separating impurity ions including alkaline earth metals and aluminium from an aqueous solution, comprising:
A cathode chamber containing a cathode and at least one boundary of the cathode chamber being formed by an anion exchange membrane;
An anode chamber containing an anode and at least one boundary of the anode chamber being formed from a cation exchange membrane;
A central chamber formed between said anion and cation exchange membranes;
A power source connected to the anode and the cathode to facilitate applying a current therebetween; and
Wherein an aqueous feed solution containing impurity ions is fed to the cathode chamber where impurity ions are precipitated as hydroxides and chloride ions migrate through the anion exchange membrane to the central chamber, and an acidic electrolyte solution is fed to the anode chamber where hydroxide ions are generated and migrate through the cation exchange membrane to the central chamber to form hydrochloric acid in the central chamber and an impurity depleted aqueous solution in the cathode chamber.

15. A three chamber electrochemical cell for separating magnesium and/or aluminium ions from an aqueous solution, comprising:
A cathode chamber containing a cathode and at least one boundary of the cathode chamber being formed by an anion exchange membrane;
An anode chamber containing an anode and at least one boundary of the anode chamber being formed from a cation exchange membrane;
A central chamber formed between said anion and cation exchange membranes;
A power source connected to the anode and the cathode to facilitate applying a current therebetween; and
Wherein an aqueous feed solution containing magnesium and/or aluminium ions is fed to the cathode chamber where they are precipitated as hydroxides and chloride ions migrate through the anion exchange membrane to the central chamber, and an acidic electrolyte solution is fed to the anode chamber where hydroxide ions are generated and migrate through the cation exchange membrane to the central chamber to form hydrochloric acid in the central chamber, and a magnesium and/or aluminium depleted aqueous solution is formed in the cathode chamber.

16. A three chamber electrochemical cell for separating magnesium and/or aluminium ions from a metallurgical solution, comprising:
A cathode chamber containing a cathode and at least one boundary of the cathode chamber being formed by an anion exchange membrane;
An anode chamber containing an anode and at least one boundary of the anode chamber being formed from a cation exchange membrane;
A central chamber formed between said anion and cation exchange membranes;
A power source connected to the anode and the cathode to facilitate applying a current therebetween; and
Wherein a metallurgical feed solution containing magnesium and/or aluminium ions is fed to the cathode chamber where they are precipitated as hydroxides and chloride ions migrate through the anion exchange membrane to the central chamber, and an acidic electrolyte solution is fed to the anode chamber where hydroxide ions are generated and migrate through the cation exchange membrane to the central chamber to form hydrochloric acid in the central chamber, and a magnesium and/or aluminium depleted metallurgical solution is formed in the cathode chamber.

17. The electrochemical cell of claim 14 wherein the electrochemical cell is configured for use as a stand-alone cell.

18. The electrochemical cell of claim 14 wherein the electrochemical cell is incorporated as part of an inline continuous flow operation.

19. The method of removing impurities of claim 1, wherein the method is utilizes a stand-alone cell.

20. The method of removing impurities of claim 1, wherein the method is incorporated as part of an inline continuous flow operation.

21. The method of removing impurities of claim 6, wherein the method is utilizes a stand-alone cell.

22. The method of removing impurities of claim 6, wherein the method is incorporated as part of an inline continuous flow operation.

23. The method of removing impurities of claim 10, wherein the method is utilizes a stand-alone cell.

24. The method of removing impurities of claim 10, wherein the method is incorporated as part of an inline continuous flow operation.

25. The electrochemical cell of claim 15, wherein the electrochemical cell is configured for use as a stand-alone cell.

26. The electrochemical cell of claim 15, wherein the electrochemical cell is incorporated as part of an inline continuous flow operation.

27. The electrochemical cell of claim 16, wherein the electrochemical cell is configured for use as a stand-alone cell.

28. The electrochemical cell of claim 16, wherein the electrochemical cell is incorporated as part of an inline continuous flow operation.
